(19) United States
(12) Patent Application Publication
(10) Pub. No.: US 2016/0203024 A1
(43) Pub. Date: Jul. 14, 2016

(54) APPARATUS AND METHOD FOR ALLOCATING RESOURCES OF DISTRIBUTED DATA PROCESSING SYSTEM IN CONSIDERATION OF VIRTUALIZATION PLATFORM

(71) Applicant: Electronics and Telecommunications Research Institute, Daejeon (KR)

(72) Inventors: Hyun Hwa CHOI, Daejeon-si (KR); Byoung Seob KIM, Sejong-si (KR); Seung Jo BAE, Daejeon-si (KR)

(73) Assignee: Electronics and Telecommunications Research Institute, Daejeon (KR)

(21) Appl. No.: 14/993,785

(22) Filed: Jan. 12, 2016

(30) Foreign Application Priority Data
Jan. 14, 2015 (KR) 10-2015-0007012

(51) Int. Cl. G06F 9/50; G06F 9/48; G06F 9/455

(52) U.S. Cl. CPC G06F 9/5011; G06F 9/45558; G06F 9/4881; G06F 2009/4557

(57) ABSTRACT

Provided is an apparatus for allocating resources of a distributed data processing system by considering a virtualization platform, the apparatus including: a resource usage monitor configured to scan one or more available virtual machines that execute one or more selected tasks in one or more physical machines, and to calculate a distance between the one or more scanned available virtual machines based on physical machine information received from the one or more physical machines; and a task allocator configured to allocate the one or more selected tasks to one or more virtual machines selected from among the one or more scanned available virtual machines based on the calculated distance between the one or more scanned available virtual machines.

### CROSS-REFERENCE TO RELATED APPLICATION(S)

This application claims priority from Korean Patent Application No. 10-2015-007012, filed on Jan 14, 2015, in the Korean Intellectual Property Office, the entire disclosure of which is incorporated herein by reference for all purposes.

### BACKGROUND

1. Field

The following description generally relates to a technology for allocating resources of a distributed data processing system implemented on a virtualization platform, and more particularly to a technology for allocating resources of a distributed processing system which data transmission time between tasks performed on a virtualization platform.

2. Description of the Related Art

Various virtualization-based cloud computing services are provided based on the development of virtualization technology and the establishment of infrastructure of high-capacity hardware. In a virtualization-based cloud environment, computing resources may be supplied in a necessary amount, rather than directly purchasing and managing computing resources, and thus the computing resources may be managed in a cost-efficient and flexible manner. However, there is a drawback in that in a virtual cluster environment changed from a cluster environment, performance of a distributed data processing system implemented based on a general physical machine cluster is significantly reduced.

Korean Patent Publication No. 10-2014-0080795 discloses a load balancing method and load balancing system for Hadoop MapReduce that is implemented in a virtual environment, in which CPU occupancy rate of a virtual machine may be adjusted by comparing a remaining time required for completing a task with an average value, so that tasks performed in the virtual machine may be controlled to be finished in an identical time. However, in the load balancing method and load balancing system, a method of allocating resources to tasks te performed in virtual machines considers only an available resource size in virtual machines without considering a distance between physical machines where each virtual machine is located.

### SUMMARY

Provided is an apparatus and method for allocating resources of virtual machines to execute tasks in consideration of a relationship between physical machines in a workflow-based distributed data processing system implemented in a virtual environment.

In one general aspect, there is provided an apparatus for allocating resources of a distributed data processing system by considering a virtualization platform, the apparatus including: a resource usage monitor configured to scan one or more available virtual machines that execute one or more selected tasks in one or more physical machines, and to calculate a distance between the one or more scanned available virtual machines based on physical machine information received from the one or more physical machines; and a task allocator configured to allocate the one or more selected tasks to one or more virtual machines selected from among the one or more scanned available virtual machines based on the calculated distance between the one or more scanned available virtual machines.

The task allocator may preferentially allocate a task to a virtual machine of a physical machine where input data of the one or more selected tasks is stored, the virtual machine being selected from the one or more available virtual machines, based on the calculated distance between the one or more virtual machines.

In a case where there are two or more tasks, the task allocator may allocate a preceding task of generating an input of a task to be performed based on the calculated distance between the virtual machines and a following task to process the generated output of the preceding task to the virtual machines located in an identical physical machine. In this case, the preceding task and the following task allocated to the identical physical machine may include exchanging data in the memory of the physical machine.

When initially executed, the resource usage monitor may receive, from a user, the physical machine information that includes IP addresses or Rack IDs of physical machines, and a distance between the physical machines. Further, the resource usage monitor may calculate the distance between the physical machines based on the IP addresses and the Rack IDs of the is physical machines and the distance between the physical machines, so as to identify available virtual machines located in an identical physical machine among the one or more virtual machines and to calculate the distance between the one or more available virtual machines.

In another general aspect, there is provided a method of allocating resources of a virtualization platform, the method including: scanning one or more available virtual machines that execute one or more selected tasks in one or more physical machines; calculating a distance between the one or more scanned available virtual machines based on the physical machine information; and allocating the one or more selected tasks to one or more virtual machines selected from among the one or more scanned available virtual machines based on the calculated distance between the one or more scanned available virtual machines. The allocating of the one or more tasks may include preferentially allocating a task to a virtual machine of a physical machine where input data of the one or more selected tasks is stored. Further, the one or more tasks allocated to the virtual machine of the physical machine where the input data is stored may include receiving the input data in a memory of the physical machine.

In a case where there are two or more tasks, the allocating of the one or more tasks may include allocating a preceding task of generating an input of a task to be performed based on the calculated distance between the virtual machines and a following task to process the generated output of the preceding task to the virtual machines located in an identical physical machine.

### BRIEF DESCRIPTION OF THE DRAWINGS

FIG. 1A is a block diagram illustrating an example of an apparatus 110 for allocating resources of a workflow-based distributed data processing system in consideration of a virtualization platform.

FIG. 1B is a block diagram illustrating an example of a data processing workflow of a workflow-based distributed data processing system 100.

FIG. 2 is a diagram illustrating information used for calculating a distance between virtual machines by the apparatus 110 for allocating resources of a workflow-based distributed data processing system in consideration of a virtualization platform according to an exemplary embodiment.

FIG. 3 is a block diagram illustrating another example of a workflow-based distributed data processing system 300 according to an exemplary embodiment.

FIG. 4 is a flowchart illustrating an example of a method of allocating resources of a workflow-based distributed data processing system according to an exemplary embodiment.

FIG. 5 is a flowchart illustrating another example of a method of allocating resources of a workflow-based distributed data processing system according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Terms used throughout this specification are defined in consideration of functions according to exemplary embodiments, and can be varied according to a purpose of a user or manager, or precedent and so on. Accordingly, the terms used in the following embodiments conform to the definitions described specifically in the present disclosure, and unless particularly defined otherwise, the terms should be interpreted as having the same meaning as commonly understood by one of ordinary skill in the art to which this invention pertains.

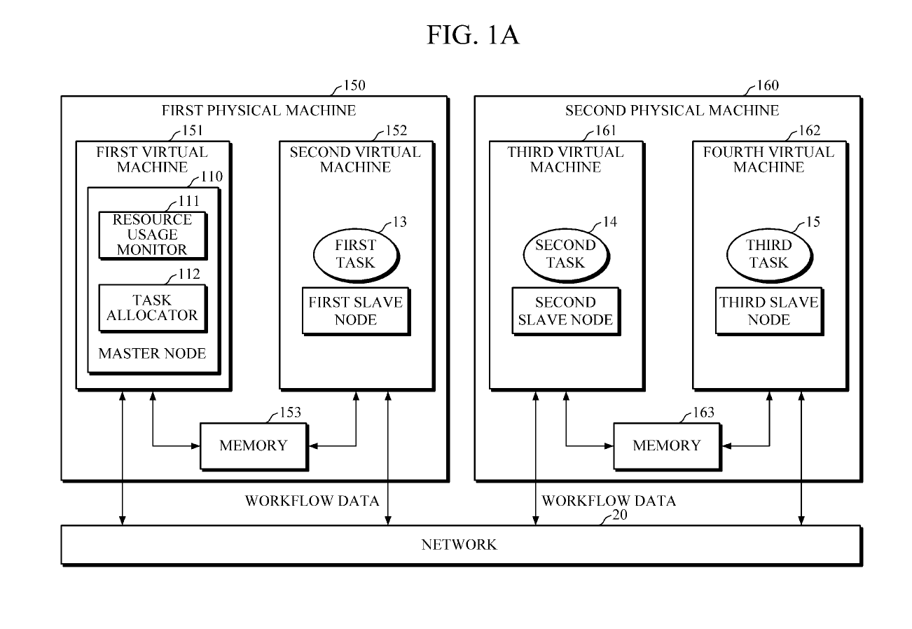

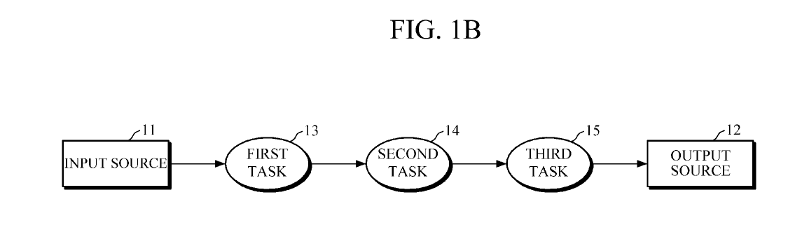

FIG. 1A is a block diagram illustrating an apparatus 110 for allocating resources of a workflow-based distributed data processing system by considering a virtualization platform according to an exemplary embodiment.

Referring to FIG. 1A, the apparatus 100 for allocating resources of a workflow-based distributed data processing system 100 allocates one or more tasks included in the workflow to virtual machines. The workflow-based distributed data processing system 100 includes batch processing such as MapReduce, and complex event processing such as StreamInsight. An input source of a workflow for data processing is data to be processed, and may be a specific network address to transmit files and stream data, and an output source thereof may also be files, a specific network address, and the like. Tasks included in a workflow represent an instruction based utility, a shell script that includes the utility, and an executable application, which are provided by an operating system.

The workflow-based distributed data processing system 100 is operated based on one or more virtual machines 151, 152, 161, and 162 that are allocated to physical machines 150 and 160. It is assumed in FIG. 1 that two virtual machines are allocated to each of the two physical machines 150 and 160. The first physical machine 150, the second physical machine 160, and the virtual machines 151, 152, 161, and 162 are connected through a network 20 so that data may be transmitted therebetween. The workflow-based distributed data processing system 100 is composed of a master node that includes the apparatus 110 for allocating resources that allocates tasks and a slave node that includes an execution module that executes tasks allocated by the apparatus 110 for allocating resources of the master node. The master node that includes the apparatus 110 for allocating resources is located in a specific virtual machine among a plurality of virtual machines. Hereinafter, for convenience of explanation, the master node that includes the apparatus 110 for allocating resources will be referred to as the apparatus 110 for allocating resources.

It is assumed in FIG. 1 that the apparatus 100 for allocating resources is located in the first virtual machine 151. That is, the first virtual machine 151, in which the apparatus 110 for allocating resources is located, serves as a master node, and the rest virtual machines serve as slave nodes that execute tasks therein according to a determination of the master node. One slave node is executed in each virtual machine, and the slave node periodically reports, to the master node, information on resources used by the virtual machines, and executes tasks allocated by the master node. Tasks included in a workflow are allocated to the virtual machines 152, 161, and 162, which are slave nodes, and are executed. FIG. 1B is a block diagram illustrating an example of a data processing workflow of a workflow-based distributed data processing system 100.

Referring to FIGS. 1A and 1B, in the workflow-based distributed data processing system 100, a workflow for processing data includes an input source 11, an output source 12, and one or more tasks 13, 14, and 15. Each of the tasks 13, 14, and 15 is allocated to one virtual machine. Further, the tasks 13, 14, and 15 are sequentially performed, starting from the first task 13, by receiving the input source 11 according to the workflow in FIG. 1B in order indicated by an arrow. The input source 11 is data to be processed, and may include a specific network address to transmit files and stream data, and an output source may include files and a specific network address. The tasks included in a workflow represent an instruction based utility, a shell script that includes the utility, and an executable application, which are provided by an operating system.

The apparatus 110 of the workflow-based distributed data processing system 100 includes a resource usage monitor 110 and a task allocator 112. When being initially executed, the task allocator 112 receives, from a user, information on physical machines where a master node and a slave node are executed. The physical machine information may include a physical machine identifier such as IP addresses and Rack IDs of physical machines, and distances between the physical machines.

The resource usage monitor 111 monitors states of one or more virtual machines 151, 152, 161, and 162 allocated to one or more physical machines 150 and 160 included in the workflow-based distributed data processing system 100, and may check virtual machine information that includes information on whether each virtual machine is available and information on available resources. The virtual machine information may include not only states of virtual machines, but also IP addresses of virtual machines for data transmission between the virtual machines, as well as IDs of virtual machines to identify the virtual machines. The virtual machine IDs for identifying each virtual machine may be replaced with the virtual machine IPs.

The task allocator 112 of the apparatus 110 for allocating resources of the workflow-based distributed data processing system 100 allocates tasks to each of one or more virtual machines 152, 161, and 162 by considering information on resources used by virtual machines serving as slave nodes (virtual machines where the apparatus for allocating resources is not located) to execute a workflow, a data flow of the workflow, and a distance between virtual machines. The distance between virtual machines may be calculated by using distances between physical machines and IP addresses or Rack IDs of the physical machines where each virtual machine is located. The distances between physical machines may be calculated by using network based response time between physical machines. In the workflow of FIG. 1B, the input source 11 is sequentially input to the first task 13, the second task 14, and the third task 15, so that the output source 12 may be output. To this end, in the case where there is one or more virtual machines having available resources when the task allocator 112 allocates resources, a task is preferentially allocated to a virtual machine that is located in the same physical machine as a physical machine of a virtual machine where the input source (input data, 11) of a task to be executed is stored.

In the case where data is transmitted between tasks not by using files but by network-based message communications, such as stream data processing, a following task is preferentially allocated to another virtual machine in a physical machine that is identical to a physical machine of a virtual machine in which a preceding task that generates input of a task to be executed is performed. In FIG. 1B, the second task 14 is a preceding task of the third task 15, and the third task 15 is a following task of the second task 14. As described above, the apparatus 110 for allocating resources of the workflow based distributed data processing system in consideration of a virtualization platform may allocate a virtual machine where a preceding task is performed and a virtual machine where a following task is performed to an identical physical machine. In this manner, when input data to be processed by each task is sequentially transmitted between virtual terminals, the input data may be exchanged in memories 153 and 163 of a physical machine without network transmission between different physical machines (physical nodes), thereby improving a data transmission speed between tasks, and increasing data processing performance.

The allocation by the apparatus 110 for allocating resources of a virtualization platform may be described below by reference to FIGS. 1A and 1B. First, it is assumed that the input source 11 is stored in the first virtual machine 151, which is a master node to which the apparatus for allocating resources of the workflow based distributed data system is allocated, and the first task 13 is transmitted to the allocated virtual machine. In this case, the task allocator 112 allocates the first task 13 to the second virtual machine 152 which is located in the first physical machine 150 where the first virtual machine 151, having an input source (input data) stored therein, is located. The input source 13 of the first virtual machine 151 is transmitted to the second virtual machine 152 in the memory 153 of the first physical machine 150. If there are available resources left in the second virtual machine 152, the task allocator 112 may allocate the second task 14 to the second virtual machine 152. However, in FIG. 1A, there are no available resources left in the second virtual machine 152, such that the task allocator 112 allocates the second task 14 to any one virtual machine (third virtual machine, 161) of another physical machine (second physical machine, 160). Then, the task allocator 112 allocates the third task 15 to the third virtual machine 162 located in the second physical machine 160 that is identical to a physical machine of the third virtual machine 161 to which the second task 14 is allocated.

As described above, the apparatus 110 of the workflow based distributed data processing system in consideration of a virtualization platform may allocate the first task 13 to the second virtual machine 152 and the third task 15 to the fourth virtual machine 162. In this case, input data is transmitted between the second virtual machine 152 where the first task 13 is allocated and the third virtual machine 161 where the second task 14 is allocated, by using a network 20 between different physical machines. However, as the second virtual machine 152 where the first task 13 is allocated and the first virtual machine 151 where the input source 11 is stored are located in the same first physical machine 150, the input source (11, input data) may be exchanged in the memory 153 of the first physical machine 150 without any need to use the network 20. Further, as the third virtual machine 161 where the second task 14 is allocated and the fourth virtual machine 162 where the third task 15 is allocated are located in the same second physical machine 160, the data between the second task 14 and the third task 15 may be exchanged in the memory 163 of the second physical machine 160 without any need to use the network 20. As described above, data between different tasks may be exchanged by using the memories 153 and 163, such that a data transmission speed may be improved as compared to the case of data transmission using the network 20.

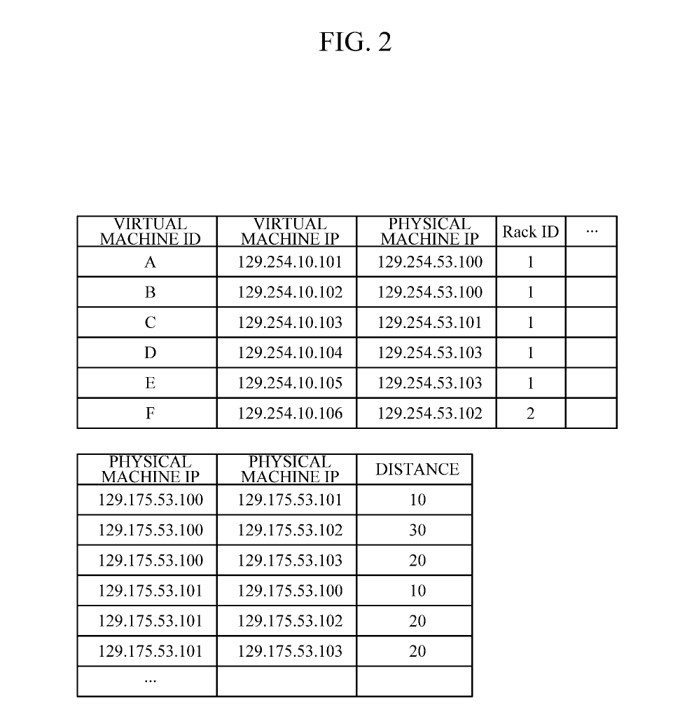

Although FIGS. 1A and 1B illustrate, for convenience of explanation, that only one task is allocated to a single virtual machine, the present disclosure is not limited thereto. When a following task is allocated to a virtual terminal that is located nearest to a virtual machine where a preceding task is allocated, the apparatus 110 for allocating resources may allocate two or more task to one virtual machine by first determining whether available resources of the virtual machine where the preceding task is allocated may perform the following task. That is, a virtual machine that is located nearest to the virtual terminal where a preceding task is allocated may be an identical virtual machine and then a virtual machine in an identical physical machine. FIG. 2 is a diagram illustrating information used for calculating a distance between virtual machines by the apparatus 110 for allocating resources of a workflow-based distributed data processing system in consideration of a virtualization platform according to an exemplary embodiment.

Referring to FIG. 2, the apparatus 110 for allocating resources of the workflow based distributed data processing system in consideration of a virtualization platform allocates tasks according to a workflow based on a distance between virtual machines. The apparatus 110 for allocating resources of the workflow based distributed data processing system in consideration of a virtualization platform uses IP addresses and Rack IDs of physical machines, and distances between the physical machines to calculate a distance between the virtual machines. The apparatus 110 for allocating resources of the workflow based distributed data processing system in consideration of a virtualization platform receives, from a user, information on physical machines where a master node and a slave node are executed. The physical machine information may include IP addresses and Rack IDs of physical machines, and distances between the physical machines. The apparatus 110 for allocating resources of the workflow based distributed data processing system in consideration of a virtualization platform is connected to each physical machine to collect distances between the physical machines. The distances between the physical machines may be measured by response time between the physical machines. The distances between the physical machines may be input from a user. Further, the apparatus 110 for allocating resources of the workflow based distributed data processing system in consideration of a virtualization platform is connected to each virtual machine to collect information on each virtual machine implemented in physical machines by using a hypervisor. The information on virtual machines may include virtual machine IP addresses necessary for data transmission between virtual machines, or virtual machine IDs to identify virtual machines. The information on virtual machines may also be input from a user.

Since it is assumed that the virtual machines may be implemented in any physical machine according to a provisioning or batch policy, it is meaningless to calculate a distance between virtual machines based on information regarding a virtual machine IP address and the like in the same manner as a method of calculating a distance between physical machines. Further, the virtual machines have no information on physical machines, in which the virtual machines are executed. Accordingly, the apparatus 100 for allocating resources of the workflow based distributed data processing system in consideration of a virtualization platform may identify virtual machines located in an identical physical machine by calculating a distance between virtual machines based on an IP address of each physical machine, and a Rack ID may also be used in the same manner as the IP addresses of physical machines. As illustrated in FIG. 2, the apparatus 110 for allocating resources of the workflow based distributed data processing system in consideration of a virtualization platform may determine that the virtual machines A and B, which have the same physical machine IP address 129.175.53.100, are located in an identical physical machine. The apparatus 110 for allocating resources of the workflow based distributed data processing system in consideration of a virtualization platform may determine that the virtual machines D and E, which have the same physical machine IP address 129.175.53.103, are located in an identical physical machine. In addition, the apparatus 110 for allocating resources of the workflow based distributed data processing system in consideration of a virtualization platform may determine that the virtual machines C and F, which have different physical machine IP addresses of 127.175.53.101 and 127.175.53.102, are located in different physical machines.

Further, by using distances between physical machines, it may be determined that virtual machine C is located nearer to the virtual machines A and B than the virtual machines D and E. In addition, virtual machines D, E, and F are located with a same distance from the virtual machine C. By using a Rack ID, it may be determined that the virtual machine C is located nearer to the virtual machines D and E than the virtual machine F, since the virtual machines D, E, and C have the same Rack ID, while the virtual machine F has a different ID. Accordingly, the apparatus 110 for allocating resources of the workflow based distributed data processing system in consideration of a virtualization platform may calculate a distance between virtual machines by considering IP addresses and Rack IDs of physical machines, and distances between the physical machines.

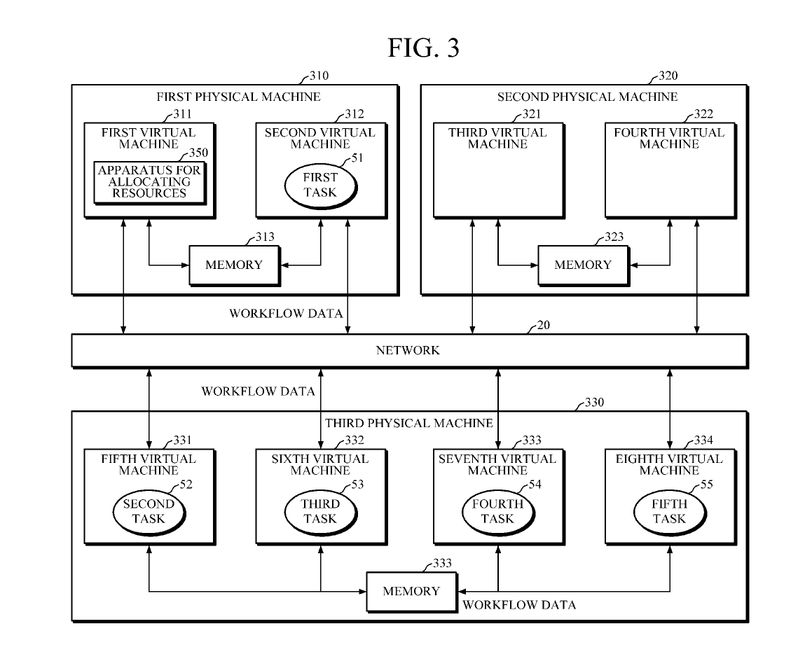

FIG. 3 is a block diagram illustrating another example of a workflow-based distributed data processing system 300 according to an exemplary embodiment.

Referring to FIG. 3, the workflow based distributed data processing system 300 includes three physical machines 310, 320, and 330. Further, the first physical machine 310 includes two available virtual machines 311 and 312, the second physical machine 320 also includes two available virtual machines 321 and 322, and the third physical machine 330 includes four available virtual machines 331, 332, 333, and 334.

When being initially operated, the apparatus 350 for allocating resources of a workflow based distributed data processing system in consideration of a virtualization platform that is allocated to the first virtual machine 311 of the first physical machine 310 receives, from a user, physical machine information that includes information on IP addresses of the physical machines. The apparatus 350 for allocating resources of a workflow based distributed data processing system in consideration of a virtualization platform collects distances between physical machines through the network 20. Further, the apparatus 350 for allocating resources of a workflow based distributed data processing system in consideration of a virtualization platform collects, through the network 20, virtual machine information that includes current states and IDs of virtual machines allocated to the first physical machine 310 to the third physical machine 330.

The apparatus 350 for allocating resources of a workflow based distributed data processing system in consideration of a virtualization platform identifies currently available virtual machines based on the collected virtual machine information. Then, the apparatus 350 for allocating resources of a workflow based distributed data processing system in consideration on of a virtualization platform calculates a distance between the identified virtual machines based on the information on physical machines. The apparatus 110 for allocating resources of workflow based distributed data processing system in consideration of a virtualization platform identifies virtual machines located in an identical physical machine based on a distance between virtual machines calculated by using the IP addresses and Rack IDs of physical machines, and distance between the physical machines.

The apparatus 350 for allocating resources of a workflow based distributed data processing system in consideration of a virtualization platform selects a task to be executed, and based on the virtual machine information, checks whether there is a virtual machine (available virtual machine) having resources required to perform the selected task. Then, the apparatus 350 for allocating resources of a workflow based distributed data processing system in consideration of a virtualization platform calculates a distance between virtual machines based on input data of the selected task and the virtual machine information, and allocates tasks to virtual machines. As illustrated in FIG. 3, the workflow is composed of five tasks including a first task 51 to a fifth task 55, in which assuming that an input source (input data) is stored in the first virtual machine 311, the apparatus 350 for allocating resources of a workflow based distributed data processing system in consideration of a virtualization platform allocates the first task 51 to the second virtual machine 312 located in the first physical machine 310 where the first virtual machine 311, having the input source (input data) stored therein, is located. The apparatus 350 for allocating resources of a workflow based distributed data processing system in consideration of a virtualization platform sequentially allocates the second task 52 to the fifth task 55 to the fifth virtual machine 331 to the eighth virtual machine 334 of the third physical machine 330. The apparatus 350 for allocating resources of a workflow based distributed data processing system in consideration of a virtualization platform allocates tasks to the fifth virtual machine 331 to the eighth virtual machine 334 located in the same physical machine 330 while excluding virtual terminals 321 and 322 of the second physical machine 320, the second task 52 to the fifth task 55 may exchange workflow data in the memory 333 of the third physical machine 330 without using the network 20 when transmitting the workflow data. Accordingly, a data transmission speed among the second task 52 to the fifth task 55 may be higher than the case of using the network 20.

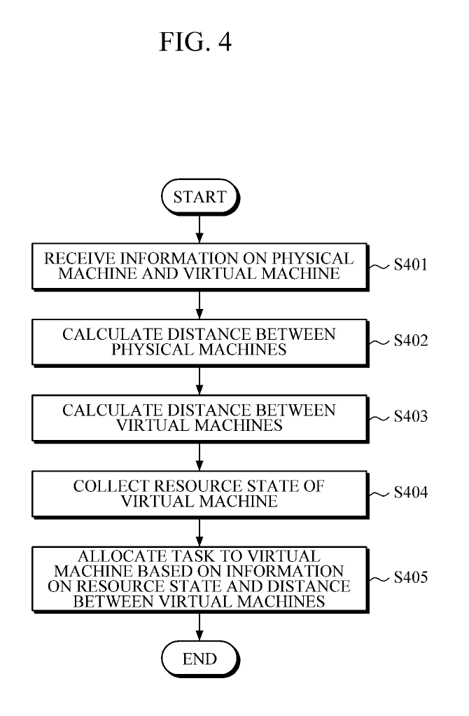

FIG. 4 is a flowchart illustrating an example of a method of allocating resources of a workflow-based distributed data processing system according to an exemplary embodiment.

Referring to FIG. 4, the method of allocating resources of a workflow based distributed data processing system includes receiving, from a user, information on physical machines and virtual machines in S401. When being initially executed, the apparatus for allocating resources included in a master node of a distributed data processing system in consideration of a virtualization platform receives, from a user, information on virtual machines where slave nodes are executed, and information on physical machines. The information on physical machines may include IP addresses and Rack IDs of virtual machines to identify each of the virtual machines. The IDs of virtual machines to identify each of the virtual machines may be replaced with the IP addresses of virtual machines.

The resource usage monitor 111 collects distances between physical machines by sending data packet through a network in S402. The apparatus 110 for allocating resources of the workflow based distributed data processing system in consideration of a virtualization platform is connected to each physical machine to collect distances between the physical machines. The distances between the physical machines may be measured by response time between the physical machines. The distances between the physical machines may be input from a user.

A distance between virtual machines may be calculated based on the information on physical machines and the information on virtual machines in S403. The apparatus for allocating resources of a virtualization platform may calculate a distance between virtual machines based on IP addresses of physical machines and distances between physical machines, and may identify virtual machines located in an identical physical machine.

Subsequently, the resource usage monitor 111 collects resource states of virtual machines through slave nodes included in the workflow based distributed data processing system in S404. The apparatus for allocating resources of a workflow based distributed data processing system collects information on whether each virtual machine is available and information on virtual machines. Further based on the information on resource states of virtual machines and the calculated distance between virtual machines, the apparatus for allocating resources of a workflow based distributed data processing system allocates tasks to virtual machines (slave nodes) in S405. The workflow for data processing of the workflow based distributed data processing system includes one or more tasks. The one or more tasks included in the workflow receive an input source to be sequentially performed, and then an output source is output. An input source of a workflow for data processing is data to be processed, and may be a specific network address to transmit files and stream data, and an output source thereof may also be files, a specific network address, and the like. Tasks included in a workflow represent an instruction based utility, a shell script that includes the utility, and an executable application, which are provided by an operating system.

The apparatus for allocating resources of a workflow based distributed data processing system in consideration of a virtualization platform allocates tasks to each of one or more virtual machines by considering a data flow of the workflow, information on resource states of virtual machines, and a distance between virtual machines so as to execute a workflow. In the case where there is one or more virtual machines having available resources when resources are allocated, a task is preferentially allocated to a virtual machine that is located in a physical machine that is identical to a physical machine of a virtual machine where the input source (input data, 11) of a task to be executed is stored. In the case where data is transmitted between tasks not by using files but by network-based message communications, such as stream data processing, a following task is preferentially allocated to another virtual machine in a physical machine that is identical to a physical machine of a virtual machine in which a preceding task that generates a task to be executed is performed. As described above, the apparatus for allocating resources of a workflow based distributed data processing system may allocate a virtual machine where a preceding task is performed and a virtual machine where a following task is performed to an identical physical machine. In this manner, when input data to be processed by each task is sequentially transmitted between virtual terminals, the input data may be exchanged in memories without network transmission between different physical machines (physical nodes), thereby improving a data transmission speed between tasks, and increasing data processing performance.

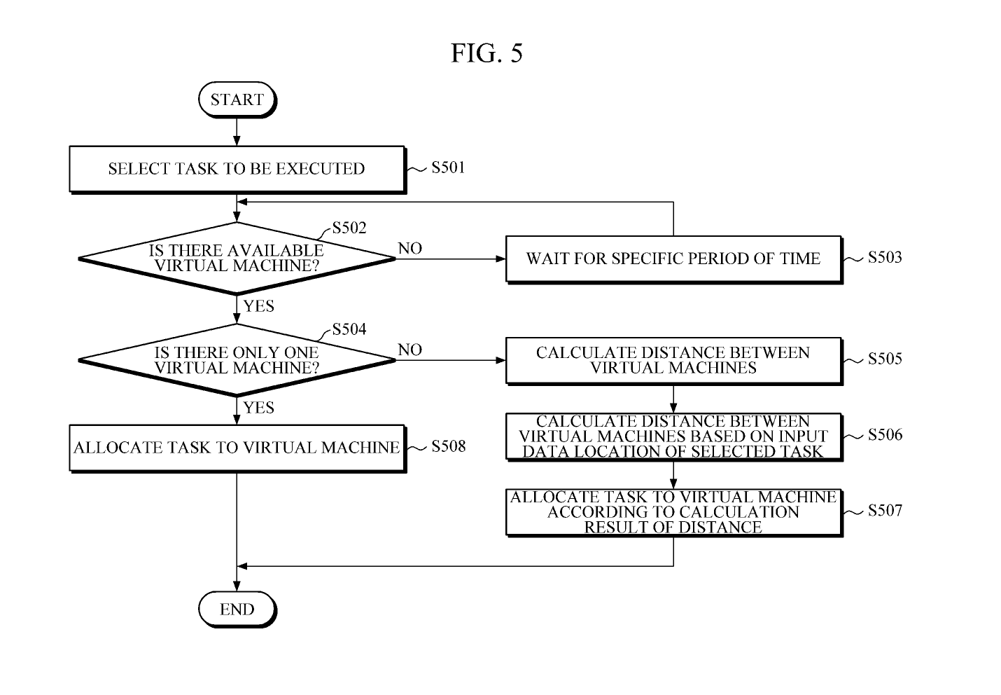

FIG. 5 is a flowchart illustrating another example of a method of allocating resources of a workflow-based distributed data processing system according to another exemplary embodiment.

Referring to FIG. 5, the method of allocating resources of a workflow-based distributed data processing system includes selecting a task to be executed in S501. The workflow for data processing of the workflow based distributed data processing system includes one or more tasks. The one or more tasks included in the workflow receive an input source to be sequentially performed, so that an output source may be output. The apparatus for allocating resources of a workflow-based distributed data processing system selects a task from the workflow, monitors resources used by the workflow based distributed data processing system, and scans virtual machines (slave nodes) having resources required for executing the selected task, so as to determine whether there is an available virtual machine in S502. The apparatus for allocating resources of a distributed data processing system in consideration of a virtualization platform may check whether there are virtual machines (slave nodes) having resources required to perform a selected task by monitoring information on resources used by the virtual machines (slave nodes). If there is no available virtual machine (slave node) in the workflow based distributed data processing system, a task is terminated or it is waited until there appears a virtual machine (slave node) that returns resources in S503.

If there is an available virtual machine (slave node) in S502, it is checked whether there is only one available virtual machine (slave node) or there are one or more available virtual machines (slave nodes) in S504. If there is only one available virtual machine (slave node), the apparatus for allocating resources of a distributed data processing system in consideration of a virtualization platform allocates a task to the available virtual machine (slave node) in S508. If there are one or more available virtual machines (slave nodes), the apparatus for allocating resources of a distributed data processing system in consideration of a virtualization platform calculates a distance between the virtual machines (slave nodes) in S505. The apparatus for allocating resources of a distributed data processing system in consideration of a virtualization platform may calculate a distance between available virtual machines by identifying IP addresses and Rack IDs of physical machines, and distance between the physical machines, in which the available virtual machines (slave nodes) are located, based on IP addresses of physical machines included in physical machine information and IDs of virtual machines included in virtual machine information. Further, the apparatus for allocating resources of a distributed data processing system by considering a virtualization platform calculates a distance between virtual machines based on an input data location of the selected task in S506. In the workflow composed of tasks, each task is performed in order starting from an input source or input data in a first task, so that an output source or output data may be calculated. Accordingly, the apparatus for allocating resources of a distributed data processing system by considering a virtualization platform calculates a virtual machine (slave node) that is located closest to a location where input data of a selected task is stored.

Then, the apparatus for allocating resources of a distributed data processing system by considering a virtualization platform allocates a task to a virtual machine (slave node) according to the calculation result of a distance in S507. The apparatus for allocating resources of a distributed data processing system by considering a virtualization platform preferentially allocates a task to an available virtual machine (slave node) included in a physical machine that is identical to a physical machine where input data is stored based on the location where the input data is stored and based on the distance between virtual machines (slave nodes). In the case where data is transmitted between tasks not by using files but by network-based message communications, such as stream data processing, a following task is preferentially allocated to another virtual machine in a physical machine that is identical to a physical machine of a virtual machine in which a preceding task that generates a task to be executed is performed. The allocation of a task to a virtual machine (slave node) based on the calculation results of a distance may be performed by reference to the description regarding FIGS. 1A and 3.

As described above, in the apparatus and method for allocating resources of a workflow-based distributed data processing system by considering a virtualization platform, a distance between virtual machines is calculated such that tasks are allocated based on the calculation, and a preceding task and a following task are allocated in a virtual machine of an identical physical machine, such that data may be exchanged in the memory of the physical machine. In this case, data is exchanged not in a network but in the memory, such that a data transmission speed may be improved, thereby reducing latency.

The exemplary embodiments described above may be written as computer programs. Further, codes and code segments needed for realizing the computer programs can be easily deduced by computer programmers in the art. Moreover, the written programs may be stored in a recording medium or in an information storage medium, and may be read and executed by a computer system to realize the present invention. The recording medium may include all types of computer-readable recording media.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for allocating resources of a distributed data processing system by considering a virtualization platform, the apparatus comprising:
a resource usage monitor configured to scan one or more available virtual machines that execute one or more selected tasks in one or more physical machines, and to calculate a distance between the one or more scanned available virtual machines based on physical machine information received from the one or more physical machines; and
a task allocator configured to allocate the one or more selected tasks to one or more virtual machines selected from among the one or more scanned available virtual machines based on the calculated distance between the one or more scanned available virtual machines.

2. The apparatus of claim 1, wherein the task allocator preferentially allocates a task to a virtual machine of a physical machine where input data of the one or more selected tasks is stored, the virtual machine being selected from the one or more available virtual machines, based on the calculated distance between the one or more virtual machines.

3. The apparatus of claim 2, wherein the one or more tasks allocated to the virtual machine of the physical machine where the input data is stored comprises receiving the input data in a memory of the physical machine.

4. The apparatus of claim 1, wherein in a case where there are two or more tasks, the task allocator allocates a preceding task of generating an input of a task to be performed based on the calculated distance between the virtual machines and a following task to process the generated output of the preceding task to the virtual machines located in an identical physical machine.

5. The apparatus of claim 4, wherein the preceding task and the following task allocated to the identical physical machine comprise exchanging data in the memory of the physical machine.

6. The apparatus of claim 1, wherein when initially executed, the resource usage monitor receives, from a user, the physical machine information that includes IP addresses or Rack IDs of physical machines, and a distance between the physical machines.

7. The apparatus of claim 1, wherein the resource usage monitor calculates the distance between the physical machines based on the IP addresses and the Rack IDs of the physical machines and the distance between the physical machines, so as to identify available virtual machines located in an identical physical machine among the one or more virtual machines and to calculate the distance between the one or more available virtual machines.

8. The apparatus of claim 1, wherein:
the resource usage monitor collects information regarding a resource state of the one or more virtual machines; and
the task allocator allocates the following task to an available virtual machine located nearest to a virtual machine where the preceding task is allocated based on the calculated distance between the virtual machines and based on the collected information regarding the resource state of the one or more virtual machines.

9. A method of allocating resources of a virtualization platform, the method comprising:
scanning one or more available virtual machines that execute one or more selected tasks in one or more physical machines;
calculating a distance between the one or more scanned available virtual machines based on physical machine information received from the one or more physical machines; and
allocating the one or more selected tasks to one or more virtual machines selected from among the one or more scanned available virtual machines based on the calculated distance between the one or more scanned available virtual machines.

10. The method of claim 9, wherein the allocating of the one or more tasks comprises preferentially allocating a task to a virtual machine of a physical machine where input data of the one or more selected tasks is stored, the virtual machine being selected from the one or more available virtual machines.

11. The method of claim 10, wherein the one or more tasks allocated to the virtual machine of the physical machine where the input data is stored comprises receiving the input data in a memory of the physical machine.

12. The method of claim 9, wherein in a case where there are two or more tasks, the allocating of the one or more tasks comprises allocating a preceding task of generating an input of a task to be performed based on the calculated distance between the virtual machines and a following task to process the generated output of the preceding task to the virtual machines located in an identical physical machine.

13. The method of claim 12, wherein the preceding task and the following task allocated to the identical physical machine comprises exchanging data in the memory of the physical machine.

14. The method of claim 9, further comprising:
when initially executed, receiving, from a user, the physical machine information that includes an IP address of the physical machine.

15. The method of claim 9, wherein the calculating the distance between the available virtual machines comprises calculating the distance between the physical machines based on the IP addresses and the Rack IDs of the physical machines and the distance between the physical machines, so as to identify available virtual machines located in an identical physical machine among the one or more virtual machines and to calculate the distance between the one or more available virtual machines.
